(19) United States
(12) Patent Application Publication
(10) Pub. No.: US 2006/0077245 A1
(43) Pub. Date: Apr. 13, 2006

(54) Image forming device

(76) Inventor: Hiromitsu Tsutsui, Nara (JP)

Correspondence Address: BIRCH STEWART KOLASCH & BIRCH, PO BOX 747, FALLS CHURCH, VA, 22040-0747, US

(21) Appl. No.: 10/532,754

(22) PCT Filed: Oct. 31, 2003
(86) PCT No.: PCT/JP03/13989

§ 371 Date: Apr. 27, 2005

(30) Foreign Application Priority Data
Nov. 1, 2002 (JP) 2002-319964

(51) Int. Cl. B41J 2/01

(52) U.S. Cl. 347/104

(57) ABSTRACT

An image forming apparatus has a feature in a sheet ejecting section thereof. With a simplified configuration, the image forming apparatus ensures that a tail end of a sheet is prevented from being lifted up at an image forming position.

The image forming apparatus has sheet ejecting rollers (4) arranged below a sheet transport path. The apparatus also has sheet pinch rollers (8), a first lift-preventing roller (1), and a second lift-preventing roller (16) arranged above the sheet transport path. The rollers (8), the roller (1), and the roller (16) are in direct contact with the rollers (4) at respective points in the sheet transport direction.

### TECHNICAL FIELD

The invention relates to an image forming apparatus which performs a process of forming an image on a sheet of paper, and in particular to an image forming apparatus having a feature in a sheet ejecting section thereof.

### BACKGROUND

Image forming apparatus such as ink jet printers have a sheet transport path leading from a sheet feeding section through an image forming position to a sheet ejecting section. A sheet is transported along the sheet transport path to the sheet ejecting section, to be ejected from the image forming apparatus onto a sheet receiving tray provided in the vicinity of the sheet ejecting section. Sequential guidance of sheets with images formed thereon to the receiving tray allows a user to pick up the sheets smoothly.

As more and more sheets are accumulated on the receiving tray, however, the sheets may sometimes block the sheet ejecting section. More specifically, a large number of sheets accumulated on the receiving tray sometimes become an obstacle to smooth ejection of subsequent sheets from the image forming apparatus.

In view of the foregoing, conventional image forming apparatus have a sheet receiving tray provided at a position lower than that of a sheet ejecting section, thereby preventing sheets accumulated on the receiving tray from blocking the sheet ejecting section.

FIG. 1 illustrates a schematic construction of an ink jet printer 100 as a typical example of a conventional image forming apparatus. As shown in FIG. 1, the ink jet printer 100 has a sheet receiving tray 107 provided at a position lower by height H than that of a sheet ejecting section. Note that the height H is here set to 20 mm or more so that 150 or more sheets P can be stacked on the receiving tray 107.

The conventional image forming apparatus as illustrated in FIG. 1 has a sheet transport path leading from a sheet feeding section through an image forming position to the sheet ejecting section. A sheet P to be transported along the sheet transport path is nipped between a platen roller 103 and a sheet holding roller 105, which are both arranged along the sheet transport path, so that the sheet P is guided downstream in a sheet transport direction.

A printhead section 112 and a lower sheet guide 114 are also provided along the sheet transport path, downstream of the platen roller 103 and the sheet holding roller 105. The image forming position is provided in a space between the printhead section 112 and the lower sheet guide 114. A sheet ejecting roller 104 and a sheet pinch roller 108 are arranged downstream of the image forming position in the transport direction.

As described above, the ink jet printer 100 has the sheet receiving tray 107 provided at a position lower by height H than that of the sheet ejecting section. Accordingly, a large number of sheets accumulated on the receiving tray do not block the sheet ejecting section.

Such conventional image forming apparatus as described above is disclosed by JP H06-071956 A, JP 2001-302054 A, and JP2002-113913 A.

[Problem to be Solved]

Because the sheet receiving tray 107 is provided at the position lower by height H than that of the sheet ejecting section, however, a tail end of the sheet P to be ejected may sometimes become in contact with the printhead section 112. This causes a new problem of improper image formation, as discussed below.

At the beginning of an image forming process, the tail end of the sheet P is nipped between the platen roller 103 and the sheet holding roller 105. As the sheet P is transported downstream in the sheet transport direction, the tail end passes through the nip area of the platen roller 103 and the sheet holding roller 105. At the end of the image forming process, the sheet P to be ejected from the ink jet printer 100 is nipped between the sheet ejecting roller 104 and the sheet pinch roller 108.

Accordingly, at the end of the image forming process, a leading end of the sheet P may sometimes hang down under its own weight, so that the tail end is lifted up, as illustrated in FIG. 1. Thus, the tail end is thus elevated above a reference level and a print surface of the sheet P becomes in contact with an ink discharging surface of the printhead section 112, so that the sheet P is contaminated with ink.

Conventional solutions to the new problem have been: a sheet receiving tray which slopes upward to a free end thereof; the sheet pinch rollers 108 which are fixedly mounted and arranged in two lines at a downstream position of the printhead section 112; and the like. However, such conventional solutions cause the ink jet printer 100 to be enlarged. Also, such conventional solutions require the sheet pinch rollers 108 to be mounted with high precision.

A feature of the present invention is to offer an image forming apparatus with a simplified configuration ensuring that a tail end of sheet is prevented from being lifted up in an image forming position.

### DISCLOSURE OF THE INVENTION

(1) An image forming apparatus of the invention includes: a sheet transport path leading from a sheet feeding section through an image forming position to a sheet ejecting section;

a lower sheet ejecting roller arranged in the sheet ejecting section below the sheet transport path; and

an upper sheet ejecting roller arranged above the sheet transport path so as to be in direct contact with the lower sheet ejecting roller,

wherein the upper sheet ejecting roller is divided in a direction perpendicular to a sheet transport direction into a plurality of portions and is in direct contact with the lower sheet ejecting roller at respective points in the sheet transport direction.

In the image forming apparatus as thus configured, the lower sheet ejecting roller and the upper sheet ejecting roller are provided in the sheet ejecting section. The sheet ejecting section is located most downstream along the sheet transport path and serves to eject a sheet out of the apparatus.

The upper sheet ejecting roller is divided in the direction perpendicular to the sheet transport direction into the plurality of portions. The portions are in direct contact with the lower sheet ejecting roller at a plurality of points in the sheet transport direction. The upper sheet ejecting roller as typically configured includes a plurality of supports which are arranged at different positions in the sheet transport direction, and component parts which are rotatably supported by the supports.

A sheet to be ejected out of the image forming apparatus is nipped at different points in the sheet transport direction between the upper sheet ejecting roller and the lower sheet ejecting roller. Thus, the sheet as thus nipped between the upper and lower sheet ejecting rollers is less likely to be turned than a sheet which is nipped at a single point between the upper and lower sheet ejecting rollers.

Accordingly, even when a leading end of a sheet being transported hangs down with its own weight, a tail end thereof is prevented from being lifted up, so that the tail end is prevented from becoming in contact with a printhead section.

Also, the sheet is allowed to keep level while passing through the image forming position. This allows a constant distance to be maintained between the sheet and the printhead section. Thus, a simplified configuration enables proper sheet transport.

(2) Part or all of the portions of the upper sheet ejecting roller are displaced from one another upstream or downstream in the sheet transport direction.

In the image forming apparatus as thus configured, the portions into which the upper sheet ejecting roller is divided are displaced from one another upstream or downstream in the sheet transport direction. The upper sheet ejecting roller is thus in direct contact with the lower sheet ejecting roller at a plurality of points in the sheet transport direction.

Accordingly, when a leading end of a sheet to be ejected out of the apparatus hangs down with its own weight, a tail end of the sheet is prevented from being lifted up.

(3) The upper sheet ejecting roller includes a sheet pinch roller, a first lift-preventing roller, and a second lift-preventing roller. The sheet pinch roller, the first lift-preventing roller, and the second lift-preventing roller are in direct contact with the lower sheet ejecting roller at respective points in the sheet transport direction.

In the image forming apparatus as thus configured, the upper sheet ejecting roller includes the sheet pinch roller, the first lift-preventing roller, and the second lift-preventing roller, all being provided at different positions in the sheet transport direction. The sheet pinch roller is positioned on the lower sheet ejecting roller, and the first and second lift-preventing rollers are positioned upstream and downstream, respectively, in the sheet transport direction of the sheet pinch roller.

Accordingly, even when a leading end of a sheet to be ejected onto a sheet receiving tray hangs down with its own weight, the first lift-preventing roller positioned upstream of the sheet pinch roller prevents a tail end of the sheet from being lifted up. Further, the second lift-preventing roller serves to guide the leading end smoothly to the sheet receiving tray which is provided below the sheet ejecting section. Furthermore, need is eliminated for a plurality of upper sheet ejecting rollers. The image forming apparatus thus can have a simplified configuration.

(4) The sheet pinch roller, the first lift-preventing roller, and the second lift-preventing roller are arranged symmetrically in relation to a center line of the sheet transport path.

In the image forming apparatus as configured above, the sheet pinch roller, the first lift-preventing roller, and the second lift-preventing roller are symmetrically arranged in relation to the center line of the sheet transport path. The center line of the sheet transport path herein is a line which is parallel to the sheet transport direction and passes through the center of the sheet transport path.

Accordingly, a sheet passing between the upper and lower sheet ejecting rollers is prevented from being skewed.

### BRIEF DESCRIPTION OF THE DRAWINGS

FIG. 1 is a diagram illustrating a schematic construction of a conventional image forming apparatus;

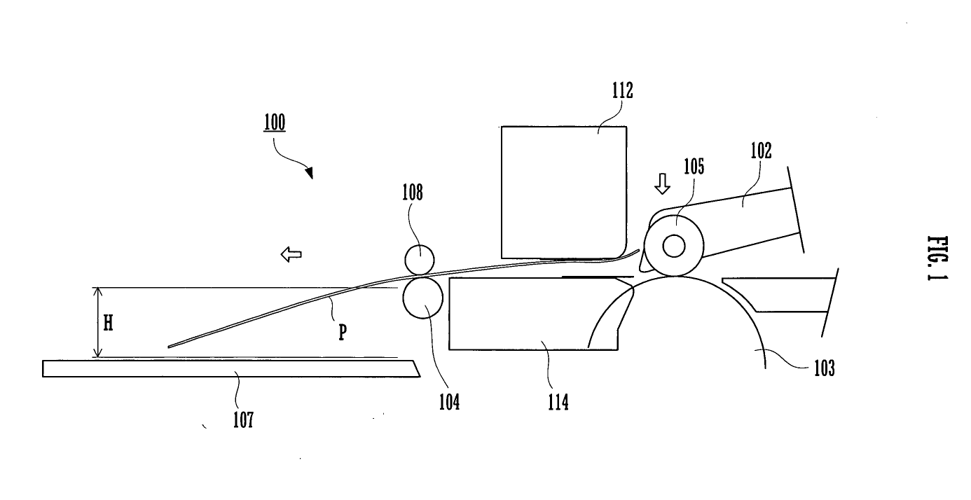

FIGS. 2(A) and 2(B) are diagrams illustrating a schematic construction of an ink jet printer of the invention;

FIG. 3 is a plan view illustrating a schematic construction of the ink jet printer; and

FIG. 4 is a block diagram illustrating a schematic construction of the ink jet printer.

### THE BEST MODE FOR CARRYING OUT THE INVENTION

With reference to the drawings, described below is an ink jet printer 20 according to an embodiment of the invention. Note that recording paper, a sheet material, ink jet printing paper, and the like are herein collectively referred to as a sheet.

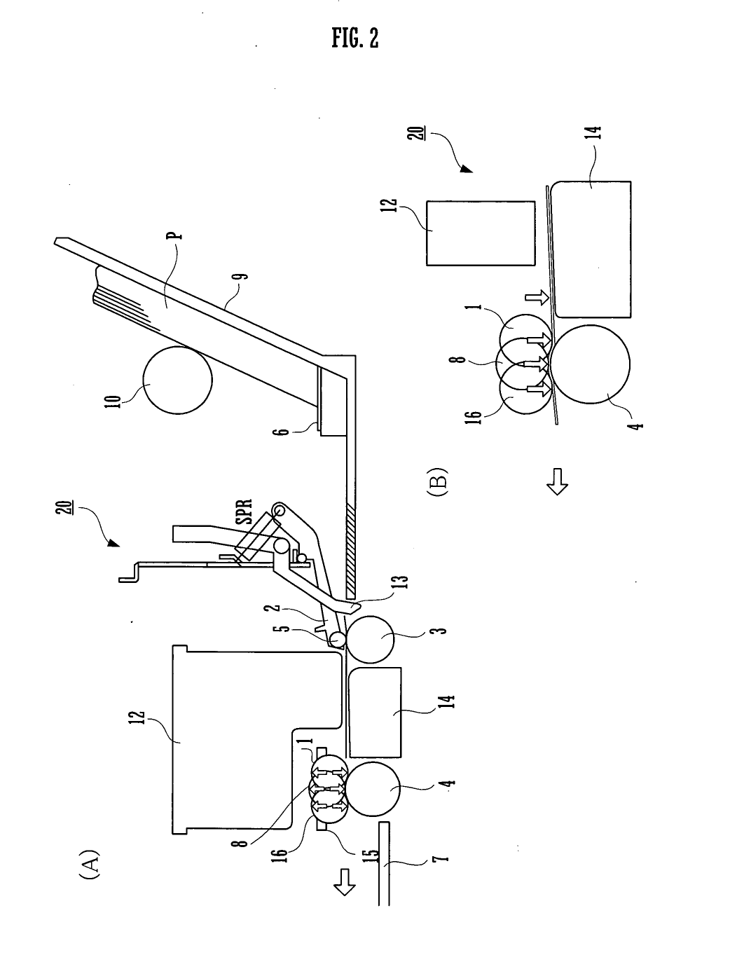

FIG. 2(A) is a diagram illustrating a schematic construction of the ink jet printer according to the embodiment. The ink jet printer 20 is provided with a sheet feeding tray 9 as a sheet feeding section. In the sheet feeding tray 9, sheets to undergo image forming processes are stored. A sheet transport path leads from the tray 9 through an image forming position to be described later, to a sheet ejecting section.

Arranged in the vicinity of the tray 9 is a sheet separating section 6 and a sheet feeding roller 10. The sheet separating section 6 picks up a top sheet P and the sheet feeding roller 10 feeds the sheet P into the sheet transport path. Arranged downstream of the tray 9 in a sheet transport direction is a sheet detecting sensor 13 for detecting passage of the sheet P.

A platen roller 3 and sheet holding rollers 5 are provided downstream of the sensor 13 along the sheet transport path. The platen roller 3 and the sheet holding rollers 5 are positioned on opposite sides of the sheet transport path, so as to be in direct contact with each other. The rollers 5 are rotatably supported by a roller holder 2.

Downstream of the platen roller 3 and the sheet holding rollers 5 in the sheet transport direction, a printhead section 12 and a lower sheet guide 14 are arranged on opposite sides of the sheet transport path. The printhead section 12 has an ink cartridge, and nozzles for discharging ink. The lower sheet guide 14 is provided below the printhead section 12 so that the sheet P is kept level while being transported. The image forming position of the invention is provided in a space between the printhead section 12 and the lower sheet guide 14.

Arranged downstream of the image forming position along the sheet transport path are sheet ejecting rollers 4 and sheet pinch rollers 8. The sheet ejecting rollers 4 and the sheet pinch rollers 8 are positioned on opposite sides of the sheet transport path, so as to be in direct contact with each other.

Conventionally, the rollers 4 and the rollers 8 are paired to form the sheet ejecting section. In the case, after a tail end of the sheet P passes between the platen roller 3 and the sheet holding rollers 5, a leading end thereof hangs down with its own weight. The sheet P is turned around nip areas of the sheet ejecting rollers 4 and the sheet pinch rollers 8, so that the tail end of the sheet P is inconveniently lifted up to come in contact with the printhead section 12.

In view of the foregoing, the ink jet printer 20 of the present embodiment has first lift-preventing rollers 1 and a second lift-preventing roller 16. The rollers 1 and the roller 16 are arranged upstream and downstream, respectively, of the sheet pinch rollers 8 along the sheet transport path, so as to be in direct contact with the sheet ejecting rollers 4. The upper sheet ejecting roller of the invention includes the sheet pinch rollers 8 for pressing the sheet P against the sheet ejecting rollers 4, the first lift-preventing rollers 1 which are arranged upstream of the rollers 8 in the sheet transport direction, and the second lift-preventing roller 16 which is arranged downstream of the rollers 8.

FIG. 2(B) illustrates a configuration of the components in the vicinity of the sheet ejecting rollers 4. Described below are respective materials and sizes of the above-discussed rollers in the present embodiment. The sheet ejecting rollers 4 are made of EPDM rubber and have a diameter of 12.0 mm. The sheet pinch rollers 8, the first lift-preventing rollers 1, and the second lift-preventing roller 16 are made of stainless steel (SUS304CSP) and have a diameter of 9.2 mm.

A sheet receiving tray 7 is provided at a position where the sheet P is ejected after passing through the sheet ejecting section which includes the sheet ejecting rollers 4, the sheet pinch rollers 8, the first lift-preventing rollers 1, and the second lift-preventing roller 16. The sheet receiving tray 7 is arranged at a position lower by 20 mm than that of the second lift-preventing roller 16.

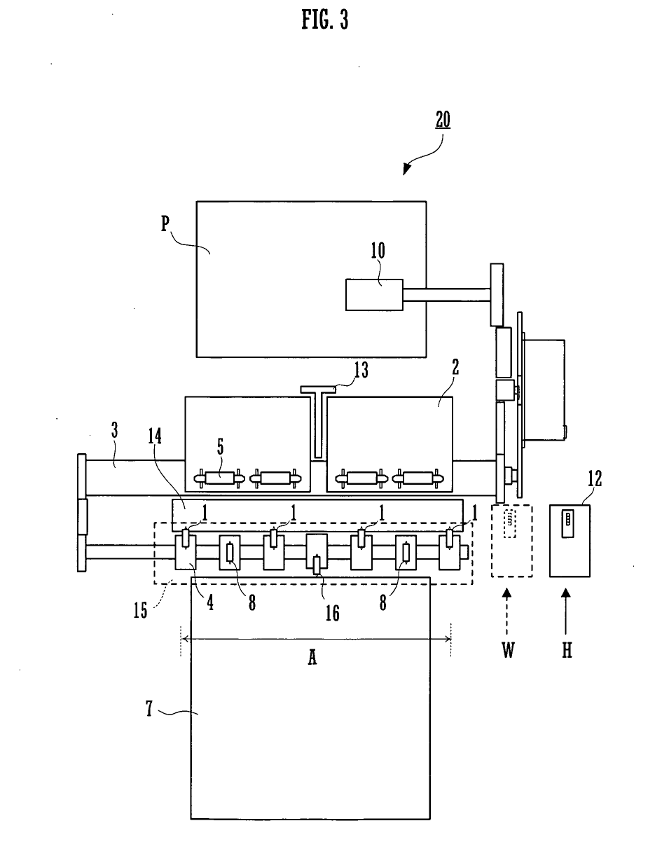

FIG. 3 is a plan view illustrating a schematic construction of the ink jet printer 20. Note that the sheet transport direction is a downward direction on the sheet of FIG. 3 and that a main scanning direction is a horizontal direction on the same. Also note that in the figure an arrow W points to a standby position of the printhead section 12 and an arrow H points to a home position of the same. Further, a range indicated by an arrow A is a print area.

As illustrated in FIG. 3, the first lift-preventing rollers 1 are attached to a sheet pinch roller guide 15. The first lift-preventing rollers 1 are constantly biased elastically toward the sheet ejecting rollers 4. A typical example of a biasing device for the rollers 1 is a spring for applying a force toward the roller 4 to the rollers 1.

The second lift-preventing roller 16 and the sheet pinch rollers 8 are also attached to the guide 15 and are constantly biased toward the rollers 4.

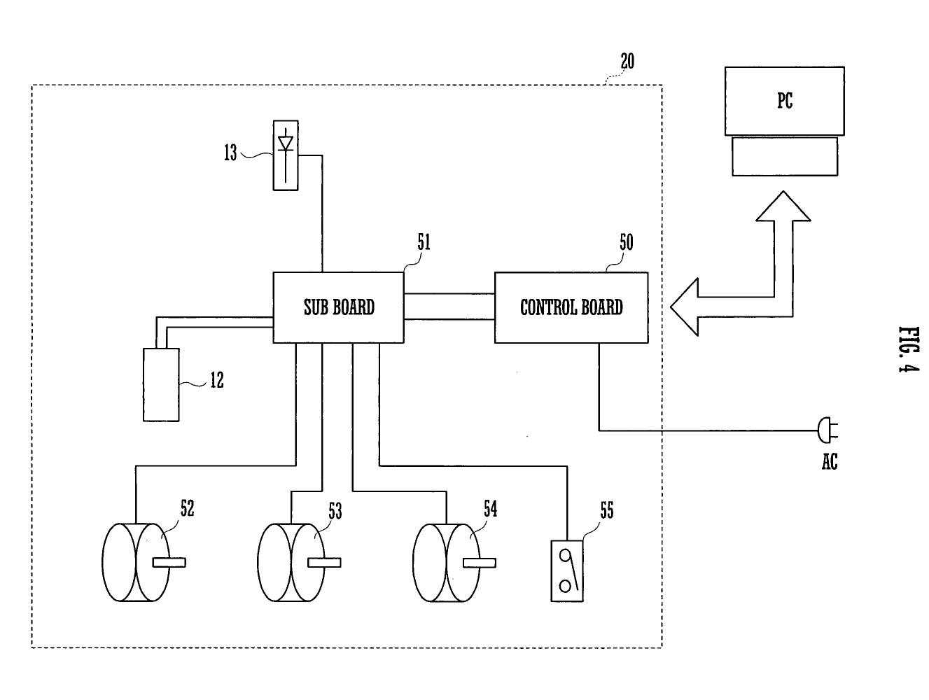

FIG. 4 is a block diagram illustrating a schematic configuration of a control system of the ink jet printer 20. As illustrated in FIG. 4, the ink jet printer 20 has a control board 50, a sub board 51, a sheet feed motor system 52, a carrier motor system 53, a maintenance motor system 54, a cam switch 55, the sheet detecting sensor 13, and the printhead section 12.

The sheet feed motor system 52 is used for transporting the sheet P. The carrier motor system 53 is used for moving the printhead section 12. The maintenance motor system 54 is used for maintenance operations such as cleaning of the printhead section 12. The cam switch 55 is used for switching power supply among the components of the ink jet printer 20, including the systems 52, 53, and 54. The sub board 51 controls operations of the respective components of the ink jet printer 20 according to a signal from the control board 50. The control board 50 is used for data communication between the printer 20 and an external PC and for analysis of operational information input through operation keys by an user.

In the ink jet printer 20, a top sheet of paper P stacked in the sheet feeding tray 9 is picked up by the sheet separating section 6 and then fed into the sheet transport path. The sheet P is transported to such a position as to turn on the sheet detecting sensor 13.

The sheet P is transported a predetermined distance until the sheet P comes in contact with the platen roller 3. Then, the sheet P is halted. At the time, the sheet feeding roller 10 is deactivated and the platen roller 3 is activated instead. The sheet P is transported in between the platen roller 3 and the sheet holding rollers 5 and then transported to a position which is approximately 1.0 to 1.5 mm upstream, in the sheet transport direction, of an ink discharge position of the printhead section 12. At the time, the sheet ejecting rollers 4 are also activated.

A leading end of the sheet P is transported to a print start position before the transport of the sheet P is halted. While traveling in the main scanning direction which is perpendicular to the sheet transport direction, the printhead section 12 discharges a jet of ink according to print data input to the control board 50. After traveling along a line for printing, the printhead section 12 returns to the standby position as pointed to by the arrow W in FIG. 3. Then, the platen roller 3 sends the sheet P exactly one line forward in the sheet transport direction, i.e., in a sub scanning direction. In the same manner, the printhead section 12 travels along subsequent lines for printing.

The sheet P is transported in the sheet transport direction, one line at a time, by the platen roller 3. After a leading end of the sheet P reaches the sheet ejecting rollers 4, the sheet P is transported in the sheet transport direction by the platen roller 3 and the rollers 4. While being transported downstream along the sheet transport path, the sheet P undergoes a printing process according to the print data. The printing process still continues after the sheet P proceeds with a tail end past the sheet detecting sensor 13 and therefore is no longer detectable by the sensor 13. As the printing process further proceeds, the tail end of the sheet P moves away from the platen roller 3. Then, the sheet P is transported by the sheet ejecting rollers 4 while undergoing the printing process to the tail end.

Even after the tail end passes through the platen roller 3 and the sheet holding rollers 5, the tail end is nipped between the first lift-preventing rollers 1 and the sheet ejecting rollers 4, and is thus prevented from being lifted up. Accordingly, the tail end proceeds along the lower sheet guide 14, so that the sheet P properly undergoes the printing process to the tail end.

The sheet pinch rollers 8 are positioned nearer the center of the sheet P in relation to the first lift-preventing rollers 1 positioned at both side portions of the sheet P, so that any one of the rollers 8 and any one of the rollers 1 are not on the same straight line parallel to the sheet transport direction. A reduced mutual interference with transport speeds of the rollers 8 and the rollers 1 allows smooth transport of the sheet P. The second lift-preventing roller 16 is positioned approximately 4 mm downstream of the rollers 8, thereby allowing the sheet P to be ejected downwards.

Any one of the first lift-preventing rollers 1, the second lift-preventing roller 16, and any one of the sheet pinch rollers 8 are not in the same straight line parallel to the sheet transport direction. Accordingly, there is a reduced mutual interference with transport speeds of the rollers 1, the roller 16, and the rollers 8.

The sheet P is transported from upwards to downwards in the sheet of FIG. 3. In the present embodiment, the first lift-preventing rollers 1, the sheet pinch rollers 8, and the second lift-preventing roller 16, i.e., seven rollers in total, are evenly spaced in a direction perpendicular to the sheet transport direction. The second lift-preventing roller 16 are positioned at the center of the seven rollers. On either side of the roller 16, the first lift-preventing roller 1, the sheet pinch roller 8, and again the first lift-preventing roller 1 are arranged in the mentioned order. Specifically, the rollers 1 and the rollers 8 are arranged symmetrically with the roller 16 as a symmetry center.

After passing through the image forming position, the leading end of the sheet P first comes in contact with the first lift-preventing rollers 1. The rollers 1 outnumber the other rollers in the direction perpendicular to the sheet transport direction. Accordingly, the leading end is unlikely to get jammed in nip areas of the sheet ejecting rollers 4 and the rollers 1, so that the sheet P is transported smoothly. Also, in the direction perpendicular to the sheet transport direction, the first lift-preventing rollers 1, the sheet pinch rollers 8, and the second lift-preventing roller 16 are arranged symmetrically in relation to a center line of the sheet transport path. The sheet P is thus prevented from being skewed while being transported.

In the present embodiment, the first lift-preventing rollers 1, the sheet pinch rollers 8, and the second lift-preventing roller 16, i.e., seven rollers in total, are evenly spaced in the direction perpendicular to the sheet transport direction. However, arrangement of the rollers is not to be considered to be limited to the foregoing one.

In the image forming apparatus as configured above, the tail end of the sheet P is prevented from being lifted up after passing through the platen roller 3. Thus, the tail end neither comes in contact with the printhead section 12 nor gets caught in sheet transport rollers. This leads to solving problems such as of the sheet P being contaminated with ink or being damaged. Also, there is allowed a reduced mutual interference with transport speeds of the sheet ejecting rollers 4, the first lift-preventing rollers 1, and the second lift-preventing roller 16. Therefore, the sheet P undergoes a proper printing process from the leading end to the tail end.

The first lift-preventing rollers 1, four in total, are attached to the sheet pinch roller guide 15 so as to be positioned preferably approximately 4 mm upstream of the sheet pinch rollers 8 along the sheet transport path. The positioning allows the sheet P to be pressed evenly by the first lift-preventing rollers 1 and the sheet ejecting rollers 4 even after the tail end of the sheet P passes through the sheet holding rollers 5. The tail end is thus prevented from being lifted up, and is thus transported along the lower sheet guide 14. Accordingly, it is possible to solve the problems such as of the sheet P being contaminated with ink or being damaged.

Also, the second lift-preventing roller 16 is positioned approximately 4 mm downstream of the sheet pinch rollers 8, so that the leading end of the sheet P is turned downward. This allows the sheet P to be smoothly guided to the sheet receiving tray 7.

Note that the sheet pinch rollers 8 and the second lift-preventing roller 16 may sometimes have different transport speeds depending on slight variations in size of component parts thereof. Therefore, when the rollers 8 and the roller 16 are arranged in the same line parallel to the sheet transport direction, there may be caused a mutual interference with transport speeds of the rollers 8 and the roller 16, so that the sheet P is prevented from being transported smoothly and is even skewed.

In the present embodiment, however, each of the sheet pinch rollers 8 are arranged between one pair of the first lift-preventing rollers 1, with a reduced mutual interference with the transport speeds. Further, the second lift-preventing roller 16 are arranged between the sheet pinch rollers 8, with a reduced mutual interference with the transport speeds. Accordingly, the sheet P being transported is prevented from being skewed.

1) An image forming apparatus, comprising:
a sheet transport path leading from a sheet feeding section through an image forming position to a sheet ejecting section;
a lower sheet ejecting roller arranged in the sheet ejecting section below the sheet transport path; and
an upper sheet ejecting roller arranged above the sheet transport path so as to be in direct contact with the lower sheet ejecting roller,
wherein the upper sheet ejecting roller is divided in a direction perpendicular to a sheet transport direction into a plurality of portions and the portions are in direct contact with the lower sheet ejecting roller at respective points in the sheet transport direction.

2) An image forming apparatus according to claim 1,
wherein part or all of the portions of the upper sheet ejecting roller are displaced from one another upstream or downstream in the sheet transport direction.

3) An image forming apparatus according to claim 1,
wherein the upper sheet ejecting roller includes a sheet pinch roller, a first lift-preventing roller, and a second lift-preventing roller, and
wherein the sheet pinch roller, the first lift-preventing roller, and the second lift-preventing roller are in direct contact with the lower sheet ejecting roller at respective points in the sheet transport direction.

4) An image forming apparatus according to claim 3,
wherein the sheet pinch roller, the first lift-preventing roller, and the second lift-preventing roller are arranged symmetrically in relation to a center line of the sheet transport path.
